(19) United States
(12) Patent Application Publication
(10) Pub. No.: US 2022/0158513 A1
(43) Pub. Date: May 19, 2022

(54) STATOR, METHOD FOR MANUFACTURING STATOR, AND MOTOR

(71) Applicant: NIDEC CORPORATION, Kyoto (JP)

(72) Inventors: Tomoya UEDA, Kyoto (JP); Yukie YAMADA, Kyoto (JP)

(21) Appl. No.: 17/598,874

(22) PCT Filed: Jan. 20, 2020
(86) PCT No.: PCT/JP2020/001699

§ 371 Date: Sep. 28, 2021

(30) Foreign Application Priority Data
Mar. 29, 2019 (JP) 2019-065558

(51) Int. Cl. H02K 3/12; H02K 15/085; H02K 1/16

(52) U.S. Cl. CPC H02K 3/12; H02K 1/16; H02K 15/085

(57) ABSTRACT

Provided is a stator including: a stator core having a plurality of teeth; and a distributed winding coil. The plurality of teeth include a first tooth having an umbrella and a second tooth having no umbrella. The first and second teeth are alternately disposed in a circumferential direction of the stator core. A slot between the first and second teeth adjacent to each other has a radial opening that opens radially. The radial opening has a circumferential width larger than a wire diameter of the coil and smaller than twice the wire diameter of the coil.

### CROSS-REFERENCE TO RELATED APPLICATIONS

This is the U.S. national stage of application No. PCT/JP2020/001699, filed on Jan. 20, 2020, and priority under 35 U.S.C. § 119(a) and 35 U.S.C. § 365(b) is claimed from Japanese Patent Application No. 2019-065558, filed on Mar. 29, 2019.

### FIELD OF THE INVENTION

The present invention relates to a stator, a method for manufacturing a stator, and a motor.

### BACKGROUND

For manufacturing a stator with distributed winding, a method for manufacturing a stator, in which aligned coils are inserted into respective slots of a stator core, has been conventionally used, for example.

However, a stator core having a tooth provided at its tip with no umbrella is required to be used to insert aligned coils into respective slots without deforming the coils.

### SUMMARY

According to an aspect of the present invention, there is provided a stator including: a stator core having a plurality of teeth arranged along a circumferential direction about a central axis; and a distributed winding coil wound around the plurality of teeth. The plurality of teeth include a first tooth having an umbrella and a second tooth having no umbrella. The first and second teeth are alternately disposed in the circumferential direction of the stator core. A slot between the first and second teeth adjacent to each other has a radial opening that opens radially. The radial opening has a circumferential width larger than a wire diameter of the coil and smaller than twice the wire diameter of the coil.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a sectional view of a motor according to an embodiment;

FIG. 2 is a cross-section view of a stator according to an embodiment;

FIG. 3 is an explanatory diagram of distributed winding;

FIG. 4 is a view illustrating a method for manufacturing a stator;

FIG. 5 is a view illustrating a modification of the method for manufacturing a stator;

FIG. 6 is a view illustrating a modification of the method for manufacturing a stator;

FIG. 7 is a view illustrating a modification of the method for manufacturing a stator;

FIG. 8 is a view illustrating a modification of the method for manufacturing a stator; and

FIG. 9 is a view illustrating a modification of the method for manufacturing a stator.

### DETAILED DESCRIPTION

Each drawing appropriately indicates Z-axis direction that is a vertical direction with a positive side being an “upper side” and a negative side being a “lower side”. Each drawing appropriately indicates a central axis J that is a virtual line parallel to the Z-axis direction and extending in the vertical direction. In the following description, an axial direction of the central axis J, i.e., a direction parallel to the vertical direction, is simply referred to as “axial direction”, a radial direction about the central axis J is simply referred to as “radial direction”, and a circumferential direction about the central axis J is simply referred to as “circumferential direction”.

In the present embodiment, the upper side corresponds to one side of an axial direction. In the present embodiment, the lower side corresponds to the other side of the axial direction. The vertical direction, the upper side, and the lower side are simply names for describing a placement relationship of each part and the like, and an actual placement relationship may be other than the placement relationship indicated by these names.

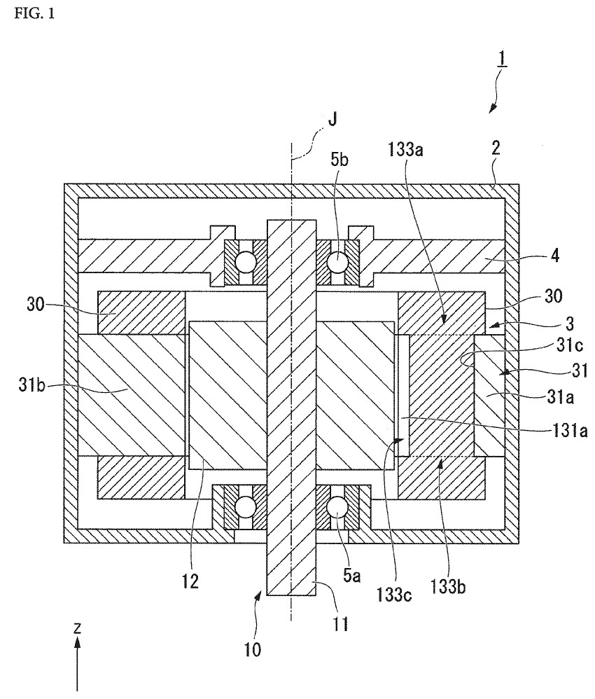

As illustrated in FIG. 1, a motor 1 of the present embodiment includes a housing 2, a rotor 10, a stator 3, a bearing holder 4, and bearings 5a and 5b. The housing 2 houses internally the rotor 10, the stator 3, the bearing holder 4, and the bearings 5a and 5b. The stator 3 is located radially outside the rotor 10. The stator 3 includes a stator core 31 and a plurality of coils 30. The plurality of coils 30 are attached to the stator core 31 with insulators interposed therebetween (not illustrated). The bearing holder 4 holds the bearing 5b.

The rotor 10 is rotatable about the central axis J. The rotor 10 includes a shaft 11 and a rotor body 12. The shaft 11 has a columnar shape about the central axis J, extending in the axial direction. The shaft 11 is rotatably supported about the central axis J by the bearings 5a and 5b. The rotor body 12 is fixed to an outer peripheral surface of the shaft 11. The rotor body 12 includes a rotor core and a plurality of magnets. Each of the magnets used for the rotor body 12 may be a permanent magnet or an electromagnet. The motor 1 may be a reluctance motor that does not use a magnet for the rotor body 12.

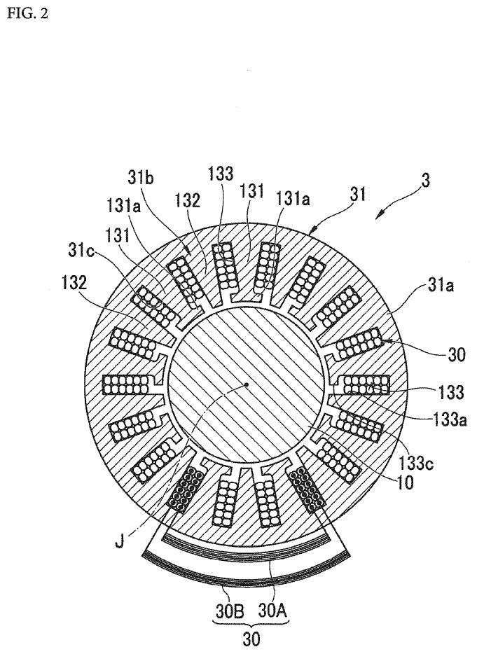

As illustrated in FIG. 2, the stator core 31 includes a core back 31a in a cylindrical shape extending in the circumferential direction and a plurality of teeth 31b extending radially inward from an inner peripheral surface of the core back 31a. The plurality of teeth 31b include a first tooth 131 having an umbrella 131a and a second tooth 132 having no umbrella.

The umbrella 131a extends from an inner peripheral end of the first tooth 131 to opposite sides in the circumferential direction. The first tooth 131 and the second tooth 132 are alternately disposed in the circumferential direction. The umbrella 131a faces a side surface of the second tooth 132, facing the circumferential direction, with a gap in the circumferential direction.

The stator core 31 has a slot 133 between the first tooth 131 and the second tooth 132 adjacent to each other in the circumferential direction. The slot 133 has axial openings 133a and 133b that open toward opposite sides in the axial direction, and a radial opening 133c that opens radially inward. The coil 30 is inserted into each of the plurality of slots 133.

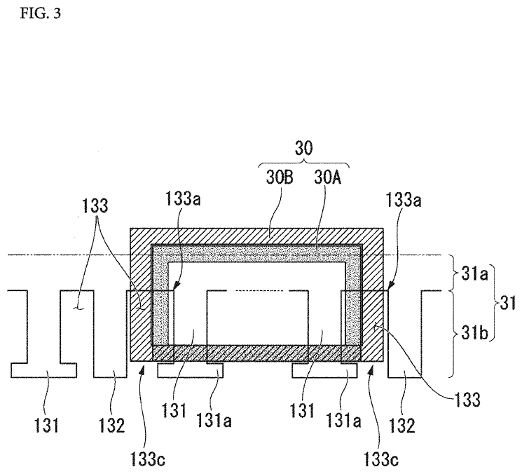

As illustrated in FIG. 3, the coil 30 is a distributed winding coil wound around the plurality of teeth 31b. In the present embodiment, one coil 30 includes an inner coil 30A and an outer coil 30B surrounding the inner coil 30A. One coil 30 is inserted into two slots 133.

As illustrated in FIG. 1, the coils 30 are each aligned in the radial direction with two windings disposed side by side in the circumferential direction per slot 133. In the two slots 133 into which one coil 30 is inserted, six windings located relatively inside in the circumferential direction serve as the inner coil 30A, and six windings located relatively outside in the circumferential direction serve as the outer coil 30B. The number of windings disposed in the slot 133 is an example, and thus can be appropriately changed.

In the present embodiment, the coil 30 has coil sides on each of which the six windings of the outer coil 30B are adjacent to the corresponding windings of the inner coil 30A in the circumferential direction. That is, the twelve windings disposed in the slot 133 are aligned in two rows in the circumferential direction, the two rows each including six windings in the radial direction. In the present embodiment, the slot 133 has a rectangular shape as viewed in the axial direction, so that a gap between the aligned coil 30 and a tooth 31b decreases. Thus, the stator 3 enables increasing not only a space factor of the coil 30 but also an occupancy rate of a coil in the slot 133. The number of windings arranged in the slot 133 can also be changed as appropriate. For example, the windings may be aligned in four rows each including three windings.

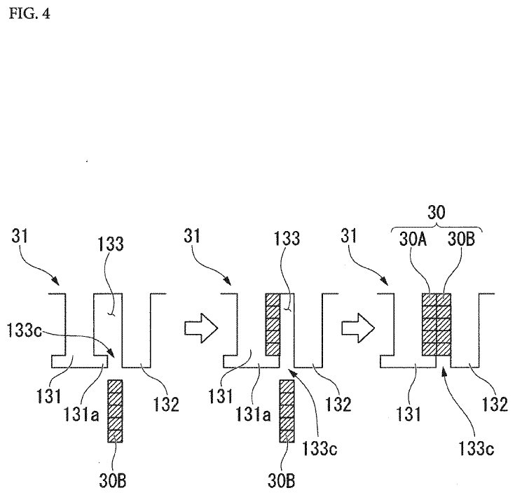

The stator 3 of the present embodiment includes first tooth 131 and second tooth 132 that are alternately disposed in the circumferential direction. Thus, the slot 133 has the radial opening 133c located in an inner peripheral end of the slot 133 at an end portion close to the second tooth 132 instead of a central portion in the circumferential direction. This structure enables the coil 30 to be disposed in the slot 133 at a high space factor without widening the radial opening 133c. Hereinafter, a specific description will be given with reference to FIG. 4.

In a manufacturing process of the stator 3, first, a process is performed in which a winding is wound with multiple turns to produce each of a formed winding coil serving as the inner coil 30A and a formed winding coil serving as the outer coil 30B. As illustrated in FIG. 4, the produced inner coil 30A and outer coil 30B each include windings that are disposed in a row in the radial direction in the coil side disposed in the slot 133.

After the formed winding coils are produced, a process is performed in which the inner coil 30A is radially inserted into the slot 133 of the stator core 31, as illustrated in FIG. 4. The windings are disposed in a row in the radial direction in the coil side of the inner coil 30A, so that the radial opening 133c of the slot 133 may have a width equal to or larger than one winding in the circumferential direction.

The inner coil 30A is inserted into the slot 133 and then moved toward the first tooth 131. This causes the inner coil 30A to be disposed radially outside the umbrella 131a. The outer coil 30B is then inserted into the slot 133 through the radial opening 133c. At this time, the inner coil 30A is retracted laterally, so that the outer coil 30B is easily inserted into the slot 133 all the way.

As described above, the coil 30 can be disposed in the slot 133 at a high space factor. In the present embodiment, the radial opening 133c between the umbrella 131a and the second tooth 132 has a circumferential width that is larger than a wire diameter of the coil 30 and smaller than twice the wire diameter of the coil 30. This enables reducing a size of the radial opening 133c of the slot 133. That is, a circumferential length of the umbrella 131a of the first tooth 131 can be increased. Thus, according to the present embodiment, an area of an inner peripheral end surface of each of the teeth 31b facing the rotor 10 can be increased, and thus torque of the motor 1 can be increased. Then, the stator 3 of the present embodiment enables the motor 1 having a small size and high torque to be fabricated.

In the present embodiment, the radial opening 133c preferably has a circumferential width larger than the wire diameter of the coil 30 and smaller than 1.5 times or less the wire diameter of the coil 30. Reducing the radial opening 133c in width enables increasing the umbrella 131a in length. This enables increasing a facing area between the stator 3 and the rotor 10, so that the torque can be increased.

In the present embodiment, the radial opening 133c preferably has a circumferential width that is larger than 1.2 times or more and 1.5 times or less the wire diameter of the coil 30. When the width of the radial opening 133c is too close to the wire diameter of the coil 30, it is difficult to perform an operation of inserting the coil 30 into the slot 133. In the radial opening 133c, an end of insulating paper in the slot 133 is disposed. Thus, to allow the radial opening 133c to have a width through which the winding can pass, the radial opening 133c needs to have a width larger than a total length of the wire diameter of the coil, a thickness of two sheets of the insulating paper, and a clearance between the winding and the coil. When the radial opening 133c has a lower limit value of a width that is 1.2 times the wire diameter, the stator 3 can be obtained in which an operation of inserting a coil into the slot 133 can be easily performed at the time of manufacturing while reducing decrease in torque of the motor 1.

In the present embodiment, the inner coil 30A and the outer coil 30B each have a coil side molded in a shape along an inner wall of the slot 133. According to this structure, the space factor of the coil 30 can be further increased. As the winding constituting the coil 30, any one of a round wire and a square wire may be used. When the round wire is used as the winding, a formed winding coil is easily produced. When the square wire is used as the winding, the space factor is likely to be increased. The stator 3 of the present embodiment allows the space factor to be easily increased even when a winding of the round wire is used.

The stator 3 of the present embodiment has an even number of rows of the coil 30. In a conventional stator in which an umbrella is provided in each of teeth, a radial opening of a slot is located at the center between the adjacent teeth. Thus, using an even number of rows of the coil causes a gap to finally remain in the slot to reduce the space factor of the coils even when the coils are inserted while retracting the coils radially outward of the umbrella. As illustrated in FIG. 4, the stator 3 of the present embodiment enables the space factor of the coils 30 to be increased even when an even number of rows of the coil is used. The stator 3 may have a structure including an odd number of rows of the coil 30.

When each tooth of a stator includes an umbrella only on one side in the circumferential direction, coils can be disposed in a slot without a gap as in the present embodiment, and thus torque equivalent to that of the present embodiment can be obtained. However, this one-sided umbrella structure causes characteristics of a motor to change depending on a rotation direction of the rotor 10. In the present embodiment, each of the first tooth 131 and the second tooth 132 has an axially symmetrical shape with respect to the radial direction as an axis, so that the motor 1 does not have a difference in characteristics due to a rotation direction of the rotor 10.

Although in the present embodiment, the slot 133 has a rectangular shape as viewed in the axial direction, the slot 133 may have a trapezoidal shape as viewed in the axial direction. That is, each of the first tooth 131 and the second tooth 132 may have a shape extending in the radial direction with a constant circumferential width. Although this structure causes the occupancy rate of a coil to be less likely to be increased as compared with the stator 3 illustrated in FIG. 1, the slot can be increased in volume, and thus output of the motor is likely to be increased.

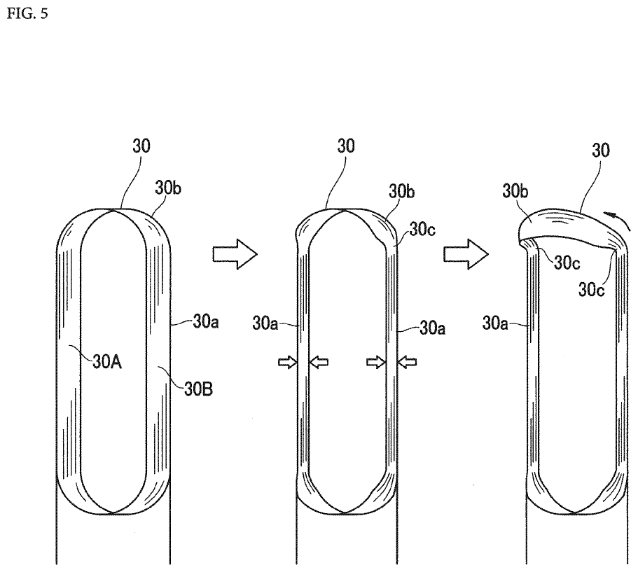

A modification of a method for manufacturing a stator will be described with reference to FIGS. 5 to 9. As illustrated in FIG. 5, the modification of a method for manufacturing a stator first performs a process in which a winding is wound multiple times to produce a coil 30 including a formed winding coil. At this time, the formed winding coil having a two-layer structure including the inner coil 30A and the outer coil 30B illustrated in FIGS. 1 to 3 is produced.

Next, a process is performed in which a coil side 30a of the coil 30 disposed in the slot 133 is pressed to be molded into an internal shape of the slot 133. As illustrated in FIG. 1, the coil side 30a is molded in a rectangular shape as viewed from the axial direction in the present embodiment. When the coil side 30a of the coil 30 is molded by press-molding, the coil side having a high space factor can be obtained even when the coil 30 is produced using a round wire. Even when a square wire is used, the coil side may be molded. For example, when the slot 133 has a trapezoidal shape as viewed in the axial direction, the space factor of the coil can be increased by molding a formed winding coil including the square wire into a trapezoidal shape in section from a rectangular shape.

The coil 30 then has a coil end 30b on one side with two boundary portions 30c that are located between coil sides 30a and the coil end 30b, and that are bent to incline the coil end 30b toward the coil sides 30a. At this time, the coil end 30b near each of the boundary portions 30c has a winding array portion 30d formed by disposing a plurality of windings side by side in a row along an extending direction of the coil sides 30a.

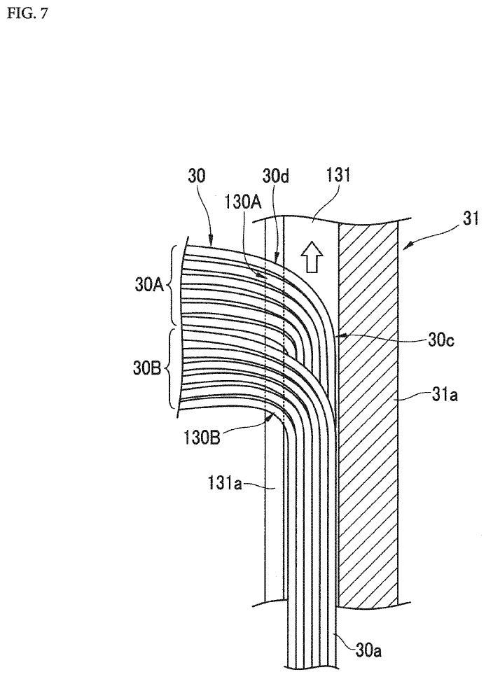

As illustrated in FIGS. 7 to 9, the winding array portion 30d includes a first array portion 130A in which the windings are disposed side by side in a row at a coil end of the inner coil 30A, and a second array portion 130B in which the windings are disposed side by side in a row at a coil end of the outer coil 30B. The coil 30 has coil sides that each include the inner coil 30A and the outer coil 30B, being disposed side by side in the circumferential direction. To form the winding array portion 30d in which the windings are disposed side by side in a row, the inner coil 30A and the outer coil are disposed to prevent their bent positions of the coil ends from overlapping each other in the extending direction of the coil sides.

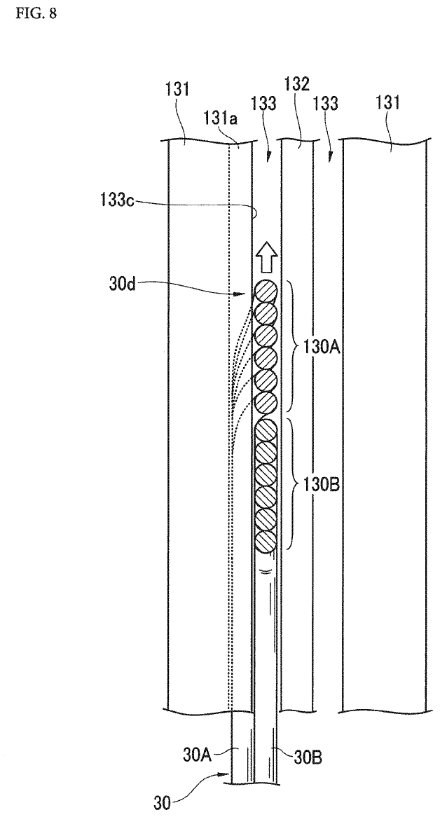

In the present embodiment, the coil end of the inner coil 30A is bent at a position above the bent position of the coil end of the outer coil 30B in the drawing. Then, as illustrated in FIG. 8, the coil end of the inner coil 30A is bent wrapping around and above the bent position of the outer coil 30B. This allows the first array portion 130A of the inner coil 30A and the second array portion 130B of the outer coil 30B to be disposed in a row along the extending direction of the coil sides.

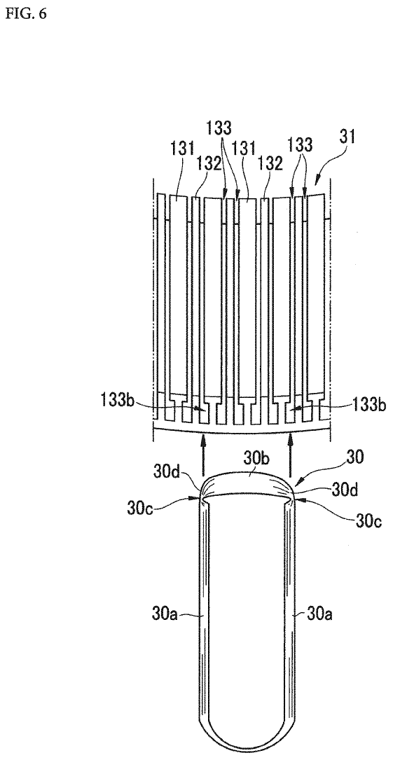

As illustrated in FIG. 6, the coil 30 bent at the coil end 30b is inserted into the two slots 133 of the stator core 31 in the axial direction while allowing the winding array portion 30d to pass through the radial opening 133c.

The windings of the coil 30 are disposed side by side in a row in the axial direction in the winding array portion 30d, so that the winding array portion 30d passes through the radial opening 133c in the axial direction as illustrated in FIGS. 7 and 8. The coil sides of the coil 30 are each inserted into the slot 133 through an axial opening 133b of the slot 133 on the lower side. The coil end 30b of the coil 30 on the upper side is disposed radially inward of the stator core 31.

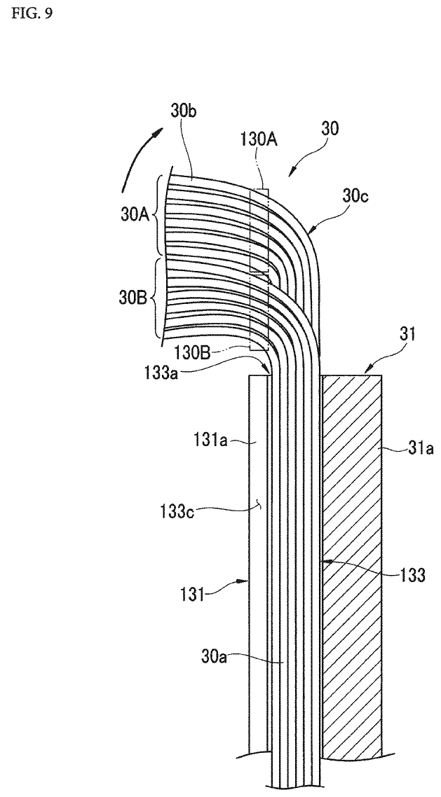

The coil 30 is moved in the axial direction in the slot 133, and as illustrated in FIG. 9, the movement is stopped at a position where the coil end 30b comes out of the axial opening 133a of the slot 133 on the upper side. The coil end 30b of the coil 30 is extended rising upward from a state of falling radially inward of the stator core 31, and is disposed above the stator core 31. This is because when the coil end 30b falls radially inward, the coil end interferes with the coil 30 to be inserted into the stator core 31 next.

After the coil end 30b is raised, the coils 30 of other phases are sequentially inserted into the stator core 31. The stator 3 is manufactured by inserting all the coils 30 into the stator core 31.

According to the manufacturing method of the modification described above, the inner coil 30A and the outer coil 30B are collectively inserted into the stator core 31, and thus the stator core 31 can be efficiently manufactured.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A stator comprising:
a stator core having a plurality of teeth arranged along a circumferential direction about a central axis; and
a distributed winding coil wound around the plurality of teeth, wherein
the plurality of teeth include a first tooth having an umbrella and a second tooth having no umbrella,
the first and second teeth are alternately disposed in the circumferential direction of the stator core,
a slot between the first tooth and the second tooth adjacent to each other includes a radial opening that opens radially, and
the radial opening has a circumferential width larger than a wire diameter of the coil and smaller than twice the wire diameter of the coil.

2. The stator according to claim 1, wherein the radial opening has the circumferential width that is larger than the wire diameter of the coil and smaller than 1.5 times or less the wire diameter of the coil.

3. The stator according to claim 1, wherein the radial opening has the circumferential width larger than 1.2 times or more and 1.5 times or less the wire diameter of the coil.

4. The stator according to claim 1, wherein the coil includes a coil side molded in a shape along an inner wall of the slot.

5. The stator according to claim 1, wherein the slot has a rectangular shape as viewed in the axial direction.

6. The stator according to claim 1, wherein the slot has a trapezoidal shape as viewed in the axial direction.

7. The stator according to claim 1, wherein an even number of rows of the coil is provided.

8. A motor comprising the stator according to claim 1.

9. A method for manufacturing a stator including a stator core having a plurality of teeth arranged along a circumferential direction about a central axis and a distributed winding coil wound around the plurality of teeth, the method comprising:
preparing a stator core in which a first tooth having an umbrella and a second tooth having no umbrella are alternately disposed in the circumferential direction, a slot between the first tooth and the second tooth adjacent to each other has a radial opening that opens in a radial direction, and the radial opening has a circumferential width larger than a wire diameter of the coil and smaller than twice the wire diameter of the coil;
winding a winding multiple times to produce a plurality of formed winding coils;
disposing windings of one of the formed winding coils side by side in a row in the radial direction on a coil side, and inserting the windings in the radial direction from the radial opening of the stator core;
moving the coil side inserted into the slot toward the first tooth; and
disposing windings of another formed winding coil side by side in a row in the radial direction on the coil side, and inserting the windings in the radial direction from the radial opening.

10. A method for manufacturing a stator including a stator core having a plurality of teeth arranged along a circumferential direction about a central axis and a distributed winding coil wound around the plurality of teeth, the method comprising:
preparing a stator core in which a first tooth having an umbrella and a second tooth having no umbrella are alternately disposed in the circumferential direction, a slot between the first tooth and the second tooth adjacent to each other has a radial opening that opens in a radial direction, and the radial opening has a circumferential width larger than a wire diameter of the coil and smaller than twice the wire diameter of the coil;
winding a winding multiple times to produce a formed winding coil;
bending two boundary portions between coil sides and a coil end at the coil end on one side of the formed winding coil to allow the coil end to fall toward the coil sides;
forming a winding array portion in which the plurality of windings are disposed side by side in a row along an extending direction of the coil sides at the coil end near each of the boundary portions; and
inserting the formed winding coil into the slot at each of two places of the stator core in the axial direction while allowing the winding array portion to pass through the radial opening.

11. The method for manufacturing a stator according to claim 10, wherein the formed winding coil is inserted into the slot in the axial direction after a molded portion is formed by pressing a coil side of the formed winding coil.
